(19) United States
(12) Patent Application Publication
(10) Pub. No.: US 2025/0135697 A1
(43) Pub. Date: May 1, 2025

(54) Injection Molding Device

(71) Applicant: SEIKO EPSON CORPORATION, Tokyo (JP)

(72) Inventors: Hiroki TAKANO, Matsumoto (JP); Seijun HORIE, Matsumoto (JP)

(21) Appl. No.: 18/931,457

(22) Filed: Oct. 30, 2024

(30) Foreign Application Priority Data
Oct. 31, 2023 (JP) 2023-186312

(51) Int. Cl. B29C 45/73

(52) U.S. Cl. CPC B29C 45/73

(57) ABSTRACT

The injection molding device includes a plasticization section generating a molding material; a fixed section to which an injection mold, in which is formed a cavity, is detachably attachable, the injection mold including a first mold and a second mold; and a nozzle, wherein the second mold includes a third mold and a fourth mold arranged between the first mold and the third mold in a mold opening direction of the second mold, the cavity is formed by the third mold and the fourth mold, a passage is formed in the fourth mold, the third mold includes a first cooling section for cooling the third mold, the fourth mold includes a second cooling section for cooling the fourth mold, and a first cooling capacity of the first cooling section is different from a second cooling capacity of the second cooling section.

The present application is based on, and claims priority from JP Application Serial Number 2023-186312, filed Oct. 31, 2023, the disclosure of which is hereby incorporated by reference herein in its entirety.

### BACKGROUND

### 1. Technical Field

The present disclosure relates to an injection molding device.

### 2. Related Art

For example, JP-A-2013-204122 discloses a metal powder injection mold having a plurality of gates for introducing a metal powder injection molding material into a cavity and a runner for connecting the sprue and the gates.

Since the passage and the cavity in the injection mold are different from each other in shape, volume, and the like, there is a problem that there is a difference in the time required to complete cooling between the molding material filling the passage and the molding material filling the cavity.

### SUMMARY

According to a first aspect of the present disclosure, an injection molding device is provided. This injection molding device includes a plasticization section for plasticizing material to produce a molding material; a fixed section to which an injection mold, in which is formed a cavity for defining shape of a product, is detachably attachable, the injection mold including a first mold that is formed with a gate aperture through which the molding material flows and a second mold that moves in a direction away from the first mold by mold opening; and a nozzle formed with a flow path for guiding the molding material to the gate aperture, wherein the second mold includes a third mold and a fourth mold arranged between the first mold and the third mold in a mold opening direction of the second mold, the cavity is formed by the third mold and the fourth mold, a passage is formed in the fourth mold, through which the molding material passes from the gate aperture toward the cavity, the third mold includes a first cooling section for cooling the third mold, the fourth mold comprises a second cooling section for cooling the fourth mold, and a first cooling capacity of the first cooling section for the cavity is different from a second cooling capacity of the second cooling section for the passage.

### BRIEF DESCRIPTION OF THE DRAWINGS

FIG. 1 is an explanatory view showing a schematic configuration of an injection molding device.

FIG. 2 is a cross-sectional view showing a schematic configuration of an injection unit.

FIG. 3 is a perspective view showing a schematic configuration of a flat screw.

FIG. 4 is a schematic plan view of a barrel.

FIG. 5 is an explanatory view showing schematic configuration of a fixed section and of a clamping section.

FIG. 6 is a side view of an injection mold.

FIG. 7 is a side view of the injection mold.

FIG. 8 is a cross-sectional view of the injection mold from a direction perpendicular to the vertical direction and a mold opening direction.

FIG. 9 is a cross-sectional view of an injection mold from a direction perpendicular to the vertical direction and the mold opening direction.

FIG. 10 is a view showing the shape of a product and runners.

FIG. 11 is a side view of the surface of a first mold that faces a second mold.

FIG. 12 is a side view of the surface of a fifth mold that faces a fourth mold.

FIG. 13 is a side view of the first mold and the fifth mold in a state where the fifth mold is disposed in a recess section of the first mold.

FIG. 14 is a cross-sectional view of a third mold from a direction perpendicular to a mold clamping direction.

FIG. 15 is a cross-sectional view of the fourth mold from a direction perpendicular to the mold clamping direction.

### DESCRIPTION OF EMBODIMENTS

### A. First Embodiment

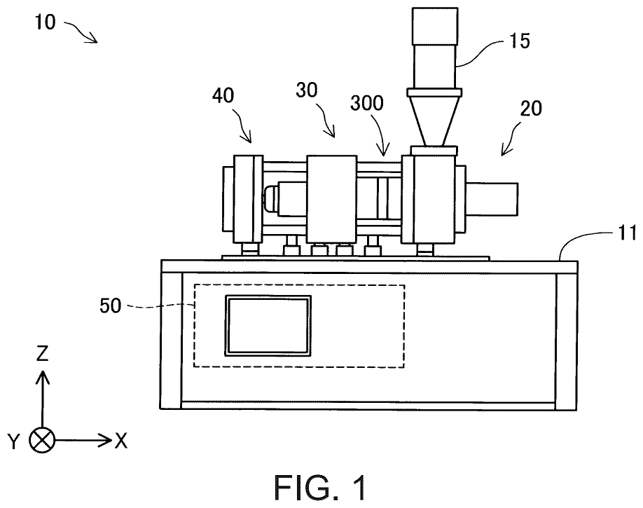

FIG. 1 is an explanatory view showing a schematic configuration of an injection molding device 10. FIG. 1 shows arrows indicating X, Y, and Z directions, which are orthogonal to each other. The X and Y directions are parallel to the horizontal plane. The Z direction is a direction parallel to the vertical direction. The X, Y, and Z directions in FIG. 1 are the same as X, Y, and Z directions in the other figures. When a direction is specified, positive and negative signs are used together with the direction notation, wherein the positive direction, which is the direction indicated by the arrow, is “+” and the negative direction, which is the direction opposite to the direction indicated by the arrow, is “−”.

An injection molding device 10 is provided with an injection unit 20, a fixed section 30, a clamping section 40, and a control section 50. The injection unit 20, the fixed section 30, and the clamping section 40 are fixed on a base 11. The injection molding device 10 is a horizontal type injection molding device, and the injection unit 20, the fixed section 30, and the clamping section 40 are arranged in the horizontal direction. The control section 50 is housed in the base 11. The injection molding device 10 molds a product by injecting a molding material from the injection unit 20 into an injection mold 300 mounted on the fixed section 30. Note that products are also referred to as molded articles.

The control section 50 is configured from a computer having one or more processors, memory, and an input/output interface for inputting and outputting signals from and to the outside. The control section 50 performs various functions, such as a function of executing a process of molding a molded article, by the processor executing a program or instructions read into the main memory. Note that the control section 50 may be realized by a configuration in which a plurality of circuits for realizing at least a part of each function are combined instead of being configured by a computer. The injection unit 20 is connected to a hopper 15 in which

the material of the molded article is contained. The injection unit 20 generates a molding material by plasticizing at least a part of the material supplied from the hopper 15, and injects the molding material into a cavity Cv formed in the injection mold 300. “Plasticizing” is a concept including melting, and means to change from a solid state to a state having fluidity. Specifically, in the case of a material in which glass transition occurs, plasticization means that the temperature of the material is made to be equal to or higher than the glass transition point. In the case of a material in which glass transition does not occur, plasticization means that the temperature of the material is set to be equal to or higher than the melting point. The material may be supplied to the injection unit 20 not only through the hopper 15 but also through, for example, a tube through which the material is pressure-fed.

The hopper 15 contains a pellet-shaped material including metal powder and a binder. As the metal powder, a single metal such as magnesium (Mg), iron (Fe), cobalt (Co), chromium (Cr), aluminum (Al), titanium (Ti), copper (Cu), or nickel (Ni), a powder containing two or more of these metals, or an alloy containing two or more of these metals is used. Examples of an alloy include maraging steel, cobalt chromium molybdenum, a titanium alloy, a nickel alloy, an aluminum alloy, a cobalt alloy, a cobalt chromium alloy, and the like. The binder includes a resin and a wax. Examples of a resin include an acrylic resin, an epoxy resin, a silicone resin, a cellulose resin, other synthetic resins, and thermoplastic resins such as polylactic acid (PLA), polyamide (PA), polyphenylene sulfide (PPS), and polyetheretherketone (PEEK).

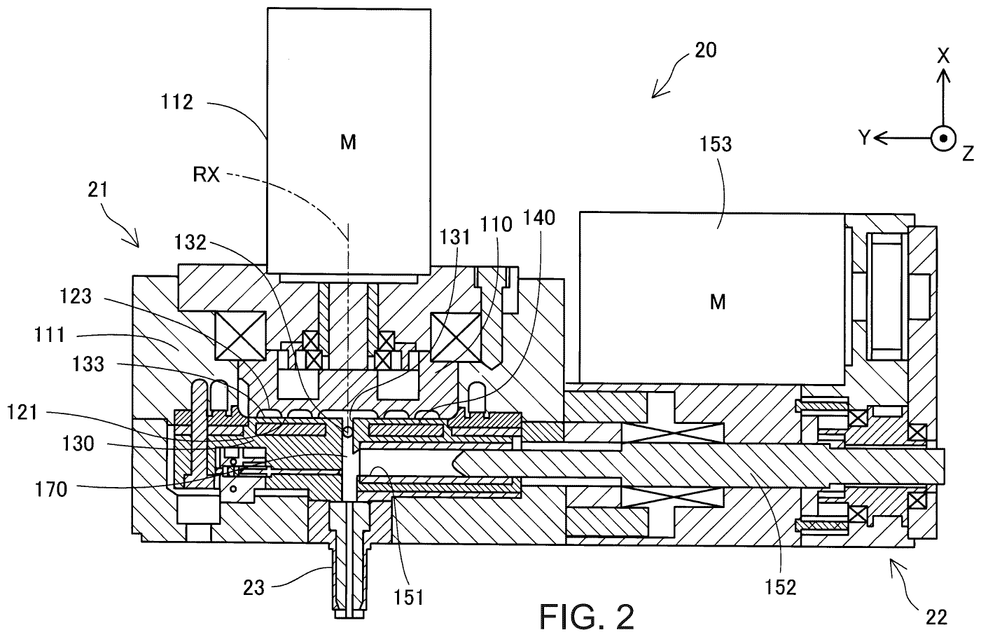

FIG. 2 is a cross-sectional view showing schematic configuration of the injection unit 20. The injection unit 20 is provided with a plasticization section 21, a suction feeding section 22, and a nozzle 23.

The plasticization section 21 plasticizes at least a part of the material supplied from the hopper 15 to produce a molding material. The plasticization section 21 includes a flat screw 110, a barrel 130, and a heater 140. The flat screw 110 is housed in a screw case 111. The flat screw 110 is also referred to as a rotor, or simply as a screw. The flat screw 110 is rotationally driven about the rotation axis RX in the screw case 111 by a drive motor 112. In this embodiment, the direction of the rotation axis RX is along the X direction. A through hole 131 is formed in the center of the barrel 130. The through hole 131 forms at least a part of the flow path 170 through which the molding material flows. An injection cylinder 151 (to be described later) is connected to the through hole 131. The through hole 131 is provided with a check valve 132 at a position upstream of the injection cylinder 151. Rotation of the flat screw 110 by the drive motor 112 and the heating by the heater 140 are controlled by the control section 50.

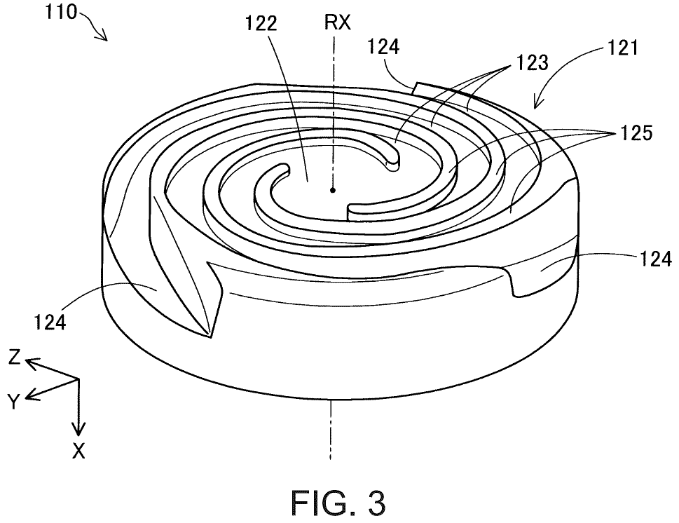

FIG. 3 is a perspective view showing a schematic configuration of the flat screw 110. The flat screw 110 has a substantially cylindrical shape whose height in the direction along the central axis thereof is smaller than its diameter. Vortex shaped grooves 123 are formed around the central section 122 on a groove forming surface 121 of the flat screw 110. The groove forming surface 121 faces the barrel 130. The grooves 123 communicate with material introduction ports 124 formed in the side surface of the flat screw 110. The material supplied from the hopper 15 is supplied to the grooves 123 through the material introduction ports 124. The grooves 123 are formed by being separated from each other by a ridge section 125. Although FIG. 3 shows an example in which three grooves 123 are formed, the number of grooves 123 may be one or two or more. The grooves 123 are not limited to a vortex shape, and may be a spiral shape, an involute curved shape, or a shape extending so as to describe an arc from the central section 122 toward the outer periphery.

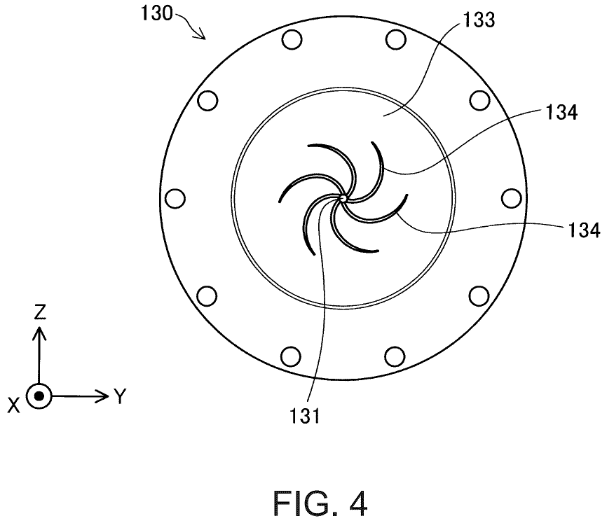

FIG. 4 is a schematic plan view of barrel 130. The barrel 130 has a facing surface 133 that faces the groove forming surface 121 of the flat screw 110. A through hole 131 is formed in the center of the facing surface 133. A plurality of guide grooves 134 connected to the through hole 131 and extending in a vortex shape from the through hole 131 toward the outer periphery are formed in the facing surface 133. While the material supplied to the grooves 123 of the flat screw 110 is plasticized between the flat screw 110 and the barrel 130 by the rotation of the flat screw 110 and the heating of the heater 140, the material flows along the grooves 123 and the guide grooves 134 by the rotation of the flat screw 110 and is guided to the central section 122 of the flat screw 110. The material flowing into the central section 122 flows out from the through hole 131 provided at the center of the barrel 130 to the suction feeding section 22. The barrel 130 may not be provided with the guide grooves 134. The guide grooves 134 may not be connected to the through hole 131.

As shown in FIG. 2, the suction feeding section 22 has an injection cylinder 151, a plunger 152, and a plunger drive section 153. The suction feeding section 22 has a function of injecting the molding material in the injection cylinder 151 into the cavity Cv of the injection mold 300. Under the control of the control section 50, the suction feeding section 22 controls injection amount, injection speed, and injection pressure of the molding material from the nozzle 23. The injection cylinder 151 is a substantially cylindrical member connected to the through hole 131 of the barrel 130, and is provided with a plunger 152 inside. The plunger 152 slides inside the injection cylinder 151, and pumps the molding material in the injection cylinder 151 to the nozzle 23 provided in the injection unit 20. The plunger 152 is driven by a plunger drive section 153 configured by a motor.

A flow path 170 is formed in the nozzle 23. The flow path 170 guides the molding material to a gate aperture 311 of the injection mold 300 (to be described later). The plunger 152 pressure-feeds the molding material in the injection cylinder 151 to the nozzle 23, so that the molding material is injected into the injection mold 300 from the nozzle 23. The nozzle 23 may be configured as an open-gate type nozzle or a valve-gate type nozzle.

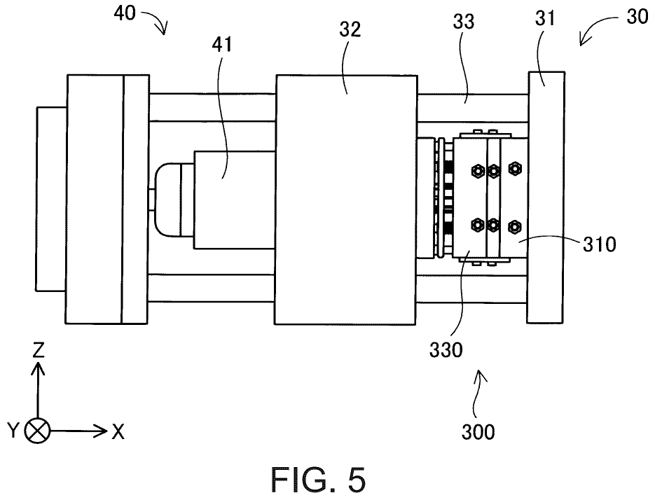

FIG. 5 is an explanatory view showing schematic configuration of the fixed section 30 and the clamping section 40. The fixed section 30 is detachably provided with the injection mold 300. The fixed section 30 includes a fixed plate 31 and a movable plate 32. The fixed plate 31 is fixed to one end of a tie bar 33 extending in the horizontal direction so that the plate surface thereof is parallel to the vertical direction. The movable plate 32 is disposed on the −X direction side of the fixed plate 31 so as to face the fixed plate 31 so that the plate surface of the movable plate 32 is parallel to the vertical direction. The movable plate 32 is provided so as to be movable along the direction in which the tie bar 33 extends. A first mold 310 of the injection mold 300 (to be described later) is mounted on the fixed plate 31, and a third mold 330 of the injection mold 300 is mounted on the movable plate 32.

The clamping section 40 opens and closes the injection mold 300 mounted on the fixed section 30. The mold clamping section 40 rotates a ball screw 41 by driving a motor (not shown) under the control of the control section 50, and moves the movable plate 32 coupled to the ball screw 41 along the tie bar 33. Clamping and opening of the injection mold 300 mounted on the fixed section 30 are performed by the movable plate 32 moving along the tie bar 33.

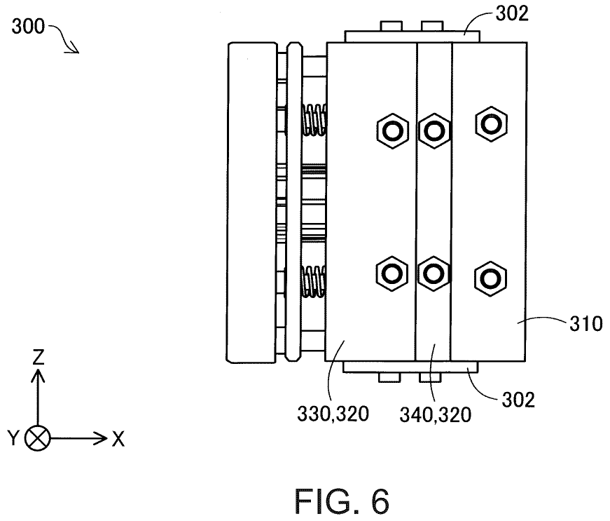

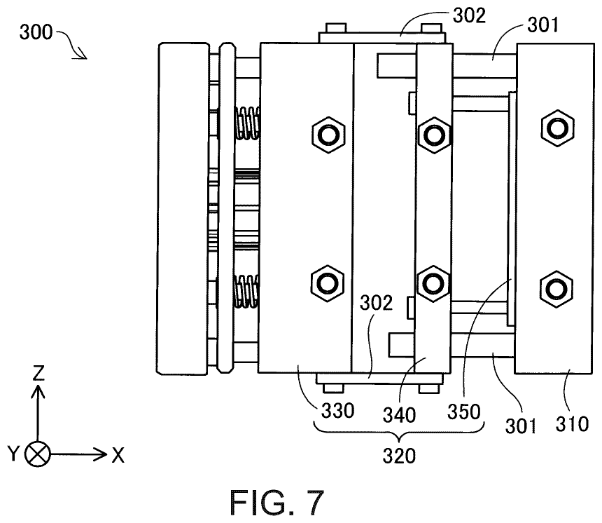

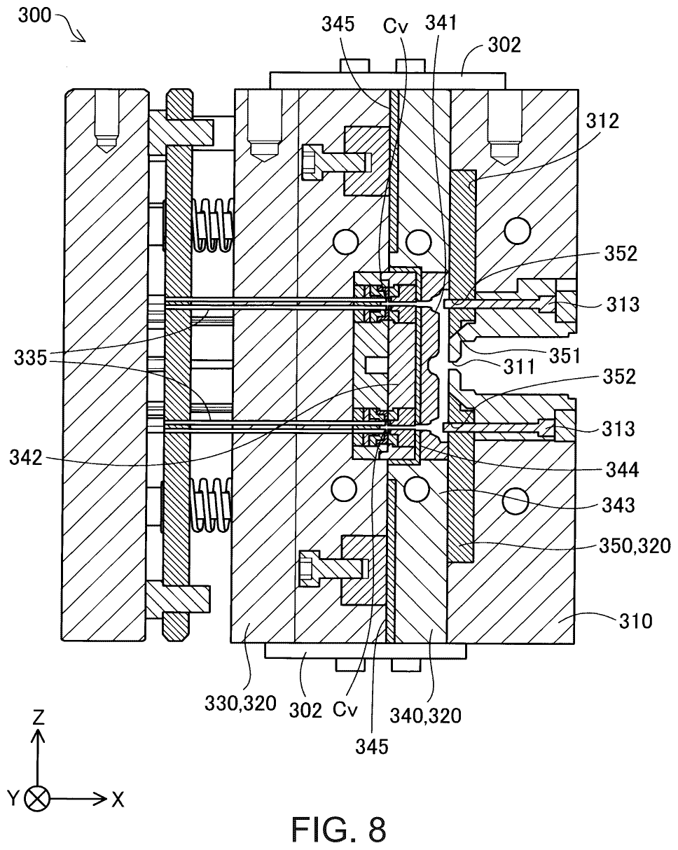

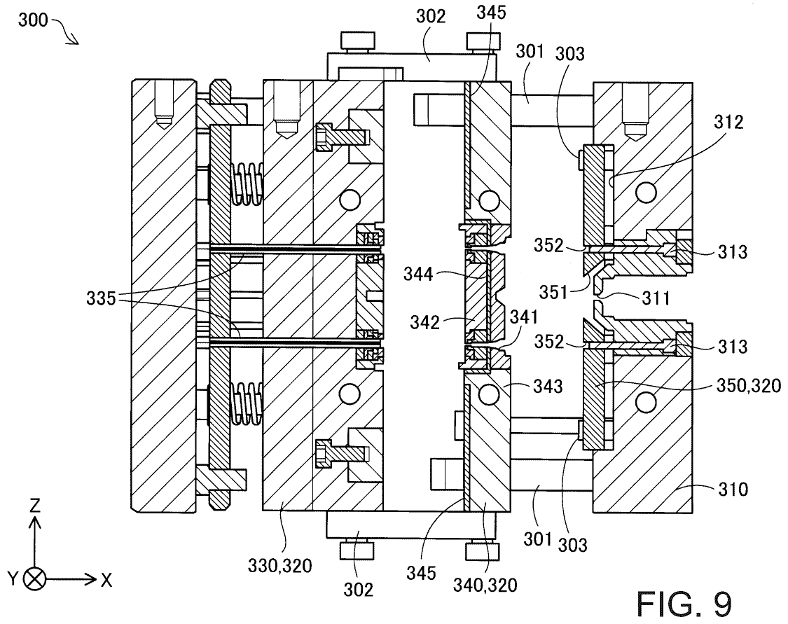

FIGS. 6 and 7 are side views of the injection mold 300. FIGS. 8 and 9 are cross-sectional views of the injection mold 300 from a direction perpendicular to the vertical direction and a mold opening direction (to be described later). FIGS. 6 and 8 show a state in which all the molds included in the injection mold 300 are closed, and FIGS. 7 and 9 show a state in which all the molds included in the injection mold 300 are open.

The injection mold 300 is provided with a first mold 310 and a second mold 320. The second mold 320 is moved in the mold opening direction by the injection mold 300 opening up. Here, the mold opening direction is a direction away from the first mold 310 and is a direction perpendicular to the vertical direction. The direction opposite to the mold opening direction is also referred to as a mold clamping direction. In this embodiment, the mold opening direction is the −X direction, and the mold clamping direction is the +X direction.

The second mold 320 includes a third mold 330, a fourth mold 340, and a fifth mold 350. The fourth mold 340 is disposed between the third mold 330 and the first mold 310 in the mold opening direction. The fifth mold 350 is disposed between the fourth mold 340 and the first mold 310 in the mold opening direction. As shown in FIG. 8, clamping of the injection mold 300 brings the third mold 330 and the fourth mold 340, the fourth mold 340 and the fifth mold 350, the fifth mold 350 and the first mold 310, and the fourth mold 340 and the first mold 310 into contact with each other. As shown in FIG. 9, the mold opening of the injection mold 300 forms spaces in the mold opening direction between the third mold 330 and the fourth mold 340, between the fourth mold 340 and the fifth mold 350, between the fifth mold 350 and the first mold 310, and between the fourth mold 340 and the first mold 310.

The first mold 310 and the fourth mold 340 are connected to each other by a first connection member 301, which is fixed to the first mold 310, so that the first mold 310 and the fourth mold 340 separate from each other by a predetermined distance by mold opening. The third mold 330 and the fourth mold 340 are connected by a second connection member 302 so that the third mold 330 and the fourth mold 340 separate by a predetermined distance by mold opening. The first mold 310 and the fifth mold 350 are connected to each other by a third connection member 303, which is fixed to the first mold 310, so that the first mold 310 and the fifth mold 350 separate from each other by a predetermined distance by mold opening.

The first mold 310 includes a gate aperture 311, a recess section 312, and support sections 313. The gate aperture 311 is a hole penetrating through the first mold 310 in the mold opening direction. When a product is to be molded, the nozzle 23 is positioned in the gate aperture 311. The molding material flows into the gate aperture 311 from the nozzle 23. The recess section 312 is formed on a surface of the first mold 310 that faces the second mold 320. The support sections 313 will be described later.

As shown in FIG. 8, when the injection mold 300 is clamped, the third mold 330 and the fourth mold 340 form a cavity Cv that defines the shape of the product. The cavity Cv is a space having a shape corresponding to the shape of the product.

The fourth mold 340 is provided with passages 341 through which molding material passes from the gate aperture 311 of the first mold 310 toward the cavity Cv. The molding material flowing from the gate aperture 311 fills the passages 341 and the cavity Cv. In this specification, the molding material that filled and solidified in the passages 341 is also referred to as runners.

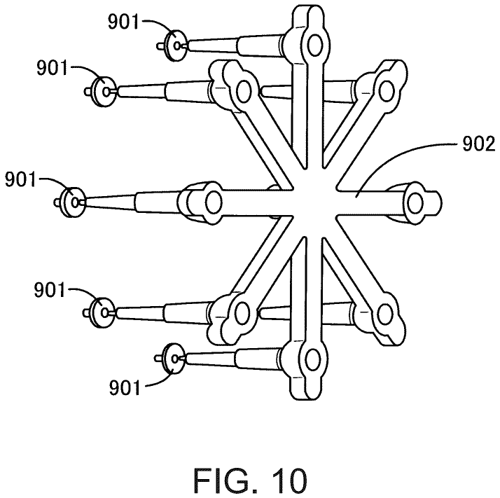

FIG. 10 is a view showing the shape of products 901 and runners 902 molded using the injection mold 300. In this embodiment, the volume of the runners 902 is greater than the volume of the products 901. That is, the volume of the passages 341 is larger than the volume of the cavity Cv. When a plurality of cavities Cv are formed by the third mold 330 and the fourth mold 340, the volume of the cavity Cv means the sum of the volumes of all the cavities Cv. In this embodiment, the volume of the passages 341 is greater than or equal to ten times the volume of the cavity Cv.

As shown in FIGS. 8 and 9, the fourth mold 340 has a first portion 342 and a second portion 343. The first portion 342 is a portion of the fourth mold 340 including a portion where the cavity Cv is formed. The second portion 343 is a portion of the fourth mold 340 excluding the first portion 342. In this embodiment, the first portion 342 is detachably provided to the second portion 343. The first portion 342 may not be detachably provided to the second portion 343.

The fourth mold 340 includes a second heat insulating member 344. The second heat insulating member 344 is provided on the fourth mold 340 so as to cover a portion where the cavity Cv is formed. In this embodiment, the second heat insulating member 344 is provided on the surface of the second portion 343 that is in contact with the first portion 342. The second heat insulating member 344 is made of, for example, ceramic or resin. The second heat insulating member 344 may be embedded in the second portion 343 instead of being provided on the surface of the second portion 343.

The fourth mold 340 has a first heat insulating member 345 for suppressing the transfer of heat between the third mold 330 and the fourth mold 340. The first heat insulating member 345 is provided on at least a portion of the surface of the fourth mold 340 that faces the third mold 330. The first heat insulating member 345 is made of, for example, ceramic or resin. The first heat insulating member 345 may be embedded in the fourth mold 340 instead of being provided on the surface of the fourth mold 340. The third mold 330 may be provided with the first heat insulating member 345 instead of the fourth mold 340, or both the third mold 330 and the fourth mold 340 may be provided with the first heat insulating member 345.

The fifth mold 350 is provided with a first through hole 351 and second through holes 352, which are holes penetrating the fifth mold 350 in the mold opening direction. The first through hole 351 is a hole through which the molding material passes from the gate aperture 311 toward the passages 341. The second through holes 352 are holes that communicate with the passages 341 in a state when the fourth mold 340 and the fifth mold 350 are in contact with each other.

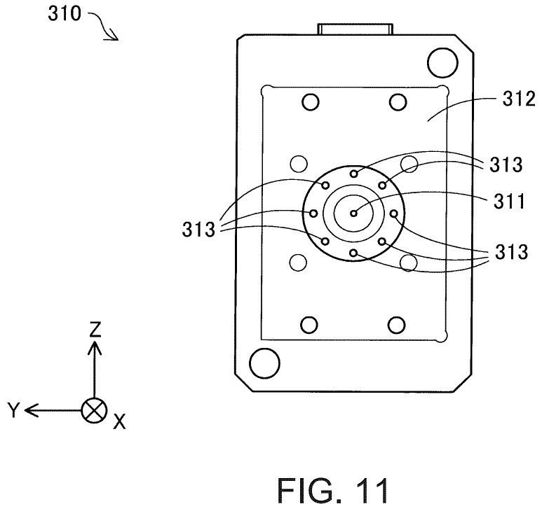

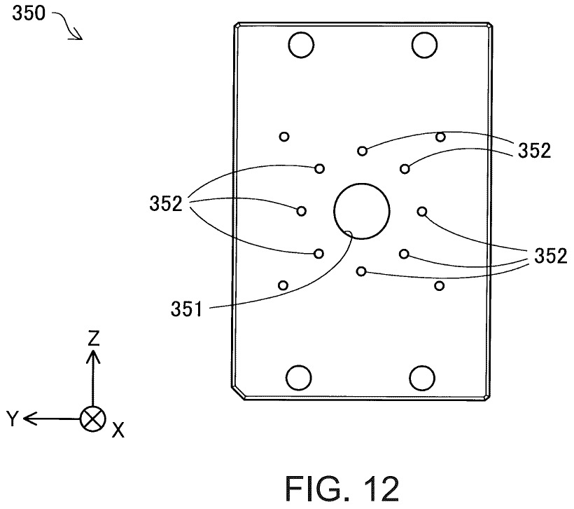

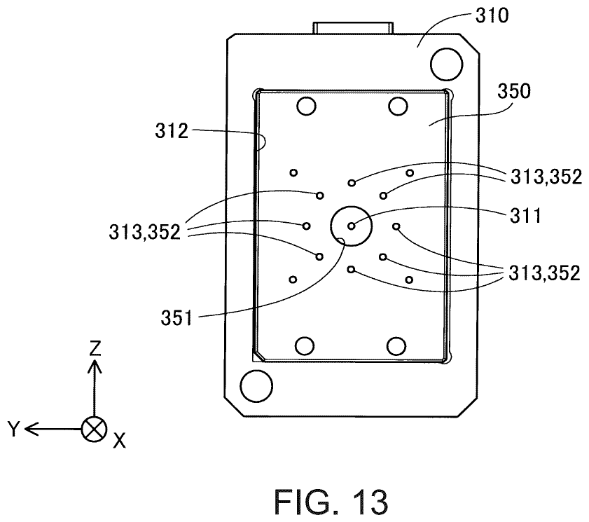

FIG. 11 is a side view of a surface of the first mold 310 that faces the second mold 320. FIG. 12 is a side view of the surface of the fifth mold 350 that faces the fourth mold 340. FIG. 13 is a side view of the first mold 310 and the fifth mold 350 in a state where the fifth mold 350 is disposed in the recess section 312 of the first mold 310. The fifth mold 350 is placed in the recess section 312 when clamping is to be performed.

The support sections 313 are columnar members protruding from the first mold 310 in the mold opening direction. The support sections 313 are inserted into the second through holes 352 of the fifth mold 350 and support the molding material filling the passages 341 of the fourth mold 340. That is, the support sections 313 support the runners 902. The support sections 313 are provided in the first mold 310 such that the tips are positioned in the passages 341 when the injection mold 300 is clamped, and the tips are accommodated in the second through holes 352 when the injection mold 300 is opened.

When the injection mold 300 is opened up, first, the third mold 330 and the fourth mold 340 are integrally moved with respect to the first mold 310 in the mold opening direction. When the first mold 310 and the fourth mold 340 are separated by a predetermined distance, the movement of the third mold 330 and the fourth mold 340 in the mold opening direction is stopped by the first connection member 301. At this time, since the runners 902 are supported by the support sections 313, they remain on the first mold 310 side. Thus, the runners 902 and the products 901 are separated from each other. Next, in a state where the fourth mold 340 is stationary, the third mold 330 moves with respect to the fourth mold 340 in the mold opening direction. When the third mold 330 and the fourth mold 340 are separated by a predetermined distance, the movement of the third mold 330 in the mold opening direction is stopped by the second connection member 302. While in a state in which a space is formed between the third mold 330 and the fourth mold 340, the products 901 are taken out from the injection mold 300 by ejector pins 335 moving in the mold clamping direction. Finally, the fifth mold 350 moves in the mold opening direction with respect to the first mold 310. When the fifth mold 350 and the first mold 310 are separated by a predetermined distance, the movement of the fifth mold 350 in the mold opening direction is stopped by the third connection member 303. By this, the support sections 313 are received in the second through holes 352 of the fifth mold 350, and the runners 902 are taken out from the injection mold 300.

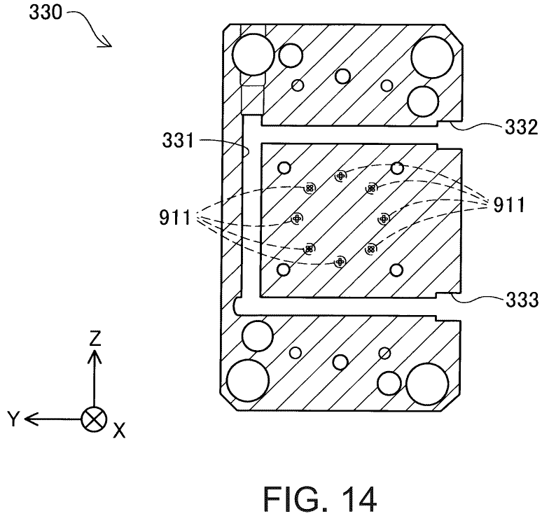

FIG. 14 is a cross-sectional view of the third mold 330 from a direction perpendicular to the mold clamping direction. As shown in FIG. 14, the third mold 330 further includes a first cooling section 331 for cooling the third mold 330. The first cooling section 331 is a refrigerant flow path through which a refrigerant flows. The refrigerant is water, oil, or the like. The third mold 330 is cooled by the refrigerant flowing through the first cooling section 331. Positions 911 where the cavity Cv is formed from the mold clamping direction are indicated in FIG. 14 by broken line. The first cooling section 331 is provided above, at the +Y direction side of, and below the positions 911 where the cavity Cv is formed.

A first refrigerant inlet 332 and a first refrigerant outlet 333 are provided on the −Y direction side surface of the third mold 330. The first cooling section 331 brings the first refrigerant inlet 332 and the first refrigerant outlet 333 into communication. The refrigerant introduced into the first cooling section 331 through the first refrigerant inlet 332 is discharged from the first refrigerant outlet 333. The refrigerant discharged from the first refrigerant outlet 333 is cooled by, for example, a chiller, and is circulated back to the first refrigerant inlet 332.

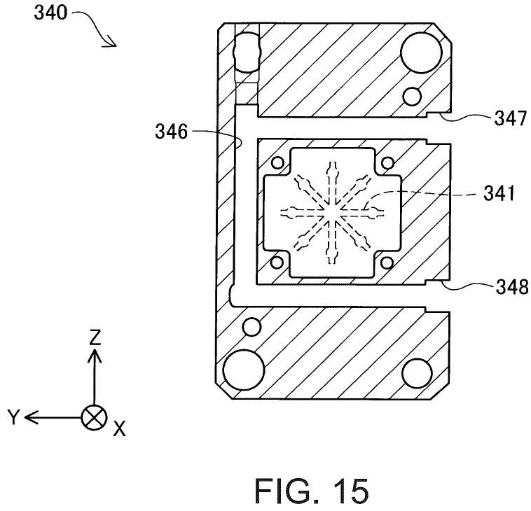

FIG. 15 is a cross-sectional view of the fourth mold 340 from a direction perpendicular to the mold clamping direction. FIG. 15 shows a cross-sectional view of the fourth mold 340 at a position including the first portion 342. The first portion 342 is not shown in FIG. 15. As shown in FIG. 15, the fourth mold 340 further includes a second cooling section 346 for cooling the fourth mold 340. The second cooling section 346 is a refrigerant flow path through which refrigerant flows. The fourth mold 340 is cooled by the refrigerant flowing through the second cooling section 346. In FIG. 15, the positions of the passages 341 from the mold clamping direction are indicated by broken line. The second cooling section 346 is provided above, on the +Y direction side of, and below the passages 341.

A second refrigerant inlet 347 and a second refrigerant outlet 348 are provided on the −Y direction side surface of the fourth mold 340. The second cooling section 346 connects the second refrigerant inlet 347 and the second refrigerant outlet 348. The refrigerant introduced from the second refrigerant inlet 347 into the second cooling section 346 is discharged from the second refrigerant outlet 348. The refrigerant discharged from the second refrigerant outlet 348 is cooled by, for example, a chiller, and is circulated back to the second refrigerant inlet 347.

The second cooling section 346 is provided in the second portion 343 of the fourth mold 340. As shown in FIGS. 8 and 9, the second heat insulating member 344 is provided on the surface of the second portion 343 that contacts the first portion 342. Because of this, the cooling capacity of the second cooling section 346 with respect to the first portion 342 is lower than cooling capacity with respect to the second portion 343.

The control section 50 controls the temperature of the first cooling section 331 and the temperature of the second cooling section 346. Specifically, the control section 50 controls the temperature of the first cooling section 331 by controlling the temperature of the refrigerant flowing through the first cooling section 331, and controls the temperature of the second cooling section 346 by controlling the temperature of the refrigerant flowing through the second cooling section 346.

Hereinafter, the cooling capacity of the first cooling section 331 for the cavity Cv is referred to as a first cooling capacity, and the cooling capacity of the second cooling section 346 for the passages 341 is referred to as a second cooling capacity. In this embodiment, the second cooling capacity is higher than the first cooling capacity. Hereinafter, a method and configuration for making the second cooling capacity higher than the first cooling capacity will be described.

The control section 50 sets the temperature of the second cooling section 346 lower than the temperature of the first cooling section 331. Specifically, the control section 50 sets the temperature of the refrigerant flowing through the second cooling section 346 to be lower than the temperature of the refrigerant flowing through the first cooling section 331. For example, the control section 50 controls the temperature of the refrigerant flowing through the second cooling section 346 to 20° C. and the temperature of the refrigerant flowing through the first cooling section 331 to 40° C. By this, the second cooling capacity becomes higher than the first cooling capacity.

The second cooling section 346 is provided in the fourth mold 340 so that the distance between the second cooling section 346 and the passages 341 is shorter than the distance between the first cooling section 331 and the cavity Cv. By this, the second cooling capacity becomes higher than the first cooling capacity.

The second cooling section 346 is provided in the fourth mold 340 so that the surface area of the second cooling section 346 with respect to the fourth mold 340 is larger than the surface area of the first cooling section 331 with respect to the third mold 330. Specifically, the area of the second cooling section 346 occupying the area of the fourth mold 340 as viewed from the X direction is larger than the area of the first cooling section 331 occupying the area of the third mold 330 as viewed from the X direction. Note that the area of the second cooling section 346 occupying the area of the fourth mold 340 viewed from a direction other than the X direction may be larger than the area of the first cooling section 331 occupying the area of the third mold 330 viewed from the same direction other than the X direction. For example, the first cooling section 331 and the second cooling section 346 are provided such that when the cross sections of the first cooling section 331 and the second cooling section 346 perpendicular to the refrigerant flow direction are the same shapes, then the cross-sectional area of the second cooling section 346 perpendicular to the refrigerant flow direction is larger than the cross-sectional area of the first cooling section 331 perpendicular to the refrigerant flow direction. By this, the second cooling capacity becomes higher than the first cooling capacity.

The thermal conductivity of the fourth mold 340 is higher than the thermal conductivity of the third mold 330. For example, the fourth mold 340 is configured from an aluminum alloy, and the third mold 330 is configured from a nickel alloy. By this, the second cooling capacity becomes higher than the first cooling capacity.

According to the injection mold 300 in the first embodiment described above, the volume of the passages 341 is larger than the volume of the cavity Cv, and the second cooling capacity of the second cooling section 346 for the passages 341 is higher than the first cooling capacity of the first cooling section 331 for the cavity Cv. Therefore, as compared with the case in which the first cooling capacity is equal to the second cooling capacity, the difference between the time required to complete cooling of the runners 902 and the time required to complete cooling of the products 901 can be reduced. Further, since the runners 902 can be cooled more powerfully than in the case where the second cooling capacity is equal to the first cooling capacity, the time required to complete cooling of the runners 902 can be shortened. As a result, the cycle time for molding the products 901 can be reduced.

When the volume of the passages 341 is larger than the volume of the cavity Cv, a molding defect may occur in the runners 902 or the products 901 if the first cooling capacity is equal to the second cooling capacity. For example, if the third mold 330 and the fourth mold 340 were cooled with a cooling capacity suitable for the runners 902, a flow failure may occur in the molding material in the cavity Cv. If the third mold 330 and the fourth mold 340 were cooled with a cooling capacity suitable for the products 901, the runners 902 may not solidify due to insufficient cooling. In this embodiment, since the second cooling capacity is higher than the first cooling capacity, the possibility of forming defects in the runners 902 or the products 901 can be reduced.

In the present embodiment, the control section 50 sets the temperature of the second cooling section 346 lower than the temperature of the first cooling section 331. Therefore, the difference between the time required to complete cooling of the runners 902 and the time required to complete cooling of the products 901 can be reduced.

In the present embodiment, the distance between the second cooling section 346 and the passages 341 is shorter than the distance between the first cooling section 331 and the cavity Cv. Therefore, the difference between the time required to complete cooling of the runners 902 and the time required to complete cooling of the products 901 can be reduced.

In this embodiment, the surface area of the second cooling section 346 with respect to the fourth mold 340 is larger than the surface area of the first cooling section 331 with respect to the third mold 330. Therefore, the difference between the time required to complete cooling of the runners 902 and the time required to complete cooling of the products 901 can be reduced.

In the present embodiment, the thermal conductivity of the fourth mold 340 is higher than the thermal conductivity of the third mold 330. Therefore, the difference between the time required to complete cooling of the runners 902 and the time required to complete cooling of the products 901 can be reduced.

In the present embodiment, the fourth mold 340 is provided with a first heat insulating member 345 for suppressing heat transfer between the third mold 330 and the fourth mold 340. Therefore, it is possible to suppress the difference between the temperature of the third mold 330 and the temperature of the fourth mold 340 from becoming small due to thermal conduction between the third mold 330 and the fourth mold 340.

In the present embodiment, the fourth mold 340 has a first portion 342 and a second portion 343, and the cooling capacity of the second cooling section 346 for the first portion 342 is lower than the cooling capacity for the second portion 343. Therefore, it is possible to suppress the first portion 342 from being cooled more than the second portion 343. Accordingly, it is possible to suppress the portion where the cavity Cv of the fourth mold 340 is formed from being cooled more than the portion where the runners 902 are formed.

In the present embodiment, the fourth mold 340 is provided with the second heat insulating member 344 covering the portion where the cavity Cv is formed. Therefore, it is possible to suppress generation of a temperature difference in the cavity Cv. As a result, it is possible to suppress the occurrence of molding defects such as warpage in the products 901.

### B. Other Embodiments

(B-1) In the above embodiment, the volume of the passages 341 is larger than the volume of the cavity Cv, and the second cooling capacity is higher than the first cooling capacity. On the other hand, the volume of the cavity Cv may be larger than the volume of the passages 341, and the first cooling capacity may be higher than the second cooling capacity. Even in this aspect, the difference between the time required to complete cooling of the products 901 and the time required to complete cooling of the runners 902 can be reduced as compared with the case where the first cooling capacity is equal to the second cooling capacity.

(B-2) In the above embodiment, the second cooling section 346 is provided in the fourth mold 340 so that the surface area of the second cooling section 346 with respect to the fourth mold 340 is larger than the surface area of the first cooling section 331 with respect to the third mold 330. On the other hand, the second cooling section 346 may be provided in the fourth mold 340 such that the surface area of the second cooling section 346 with respect to the surface area of the runners 902 is larger than the surface area of the first cooling section 331 with respect to the surface area of the products 901.

(B-3) In the above embodiment, the control section 50 sets the temperature of the second cooling section 346 lower than the temperature of the first cooling section 331. The distance between the second cooling section 346 and the passages 341 is shorter than the distance between the first cooling section 331 and the cavity Cv. The surface area of the second cooling section 346 with respect to the fourth mold 340 is larger than the surface area of the first cooling section 331 with respect to the third mold 330. The thermal conductivity of the fourth mold 340 is higher than the thermal conductivity of the third mold 330. Thus, in the above embodiment, the injection molding device 10 is provided with four ways to make the cooling capacity of the second cooling section 346 larger than the cooling capacity of the first cooling section 331. On the other hand, the injection molding device 10 may not be provided with all four ways to make the cooling capacity of the second cooling section 346 larger than the cooling capacity of the first cooling section 331, but may be provided with at least one of the four ways.

(B-4) In the above embodiment, at least one of the third mold 330 and the fourth mold 340 is provided with the first heat insulating member 345. On the other hand, neither of the third mold 330 and the fourth mold 340 may be provided with the first heat insulating member 345.

(B-5) In the above embodiment, the fourth mold 340 includes the second heat insulating member 344. On the other hand, the fourth mold 340 may not be provided with the second heat insulating member 344. That is, the cooling capacity of the second cooling section 346 for the first portion 342 may not be lower than the cooling capacity for the second portion 343.

### C. Other Aspects

The present disclosure is not limited to the above-described embodiments, and can be realized in various aspects without departing from the spirit thereof. For example, the present disclosure can also be realized by the following aspects. The technical features in the above-mentioned embodiments corresponding to the technical features in the respective aspects described below can be appropriately replaced or combined in order to solve some or all of the problems of the present disclosure or to achieve some or all of the effects of the present disclosure. Unless the technical features are described as essential in the present specification, the technical features can be appropriately deleted.

(1) According to one aspect of the present disclosure, an injection molding system is provided. This injection molding device includes a plasticization section for plasticizing material to produce a molding material; a fixed section to which an injection mold, in which is formed a cavity for defining shape of a product, is detachably attachable, the injection mold including a first mold that is formed with a gate aperture through which the molding material flows and a second mold that moves in a direction away from the first mold by mold opening; and a nozzle formed with a flow path for guiding the molding material to the gate aperture, wherein the second mold includes a third mold and a fourth mold arranged between the first mold and the third mold in a mold opening direction of the second mold, the cavity is formed by the third mold and the fourth mold, a passage is formed in the fourth mold, through which the molding material passes from the gate aperture toward the cavity, the third mold includes a first cooling section for cooling the third mold, the fourth mold comprises a second cooling section for cooling the fourth mold, and a first cooling capacity of the first cooling section for the cavity is different from a second cooling capacity of the second cooling section for the passage.

According to such an aspect, in a case where the shape, volume, and the like of the cavity and the passage are different from each other, the difference between the time required to complete cooling of the molding material filling the passage and the time required to complete cooling of the molding material filling the cavity can be reduced.

(2) The above aspect may be such that a volume of the passage is greater than a volume of the cavity and the second cooling capacity is higher than the first cooling capacity.

According to such an aspect, the difference between the time required to complete cooling of the molding material filling the passage and the time required to complete cooling of the molding material filling the cavity can be reduced as compared with the case where the first cooling capacity and the second cooling capacity are equal.

(3) The above aspects may be such that they further include a control section that controls temperature of the first cooling section and temperature of the second cooling section, wherein the control section controls the temperature of the second cooling section to be lower than the temperature of the first cooling section.

According to such an aspect, the difference between the time required to complete cooling of the molding material filling the passage and the time required to complete cooling of the molding material filling the cavity can be reduced.

(4) The above aspects may be such that a distance between the second cooling section and the passage is shorter than a distance between the first cooling section and the cavity.

According to such an aspect, the difference between the time required to complete cooling of the molding material filling the passage and the time required to complete cooling of the molding material filling the cavity can be reduced.

(5) The above aspects may be such that a surface area of the second cooling section with respect to the fourth mold is larger than a surface area of the first cooling section with respect to the third mold.

According to such an aspect, the difference between the time required to complete cooling of the molding material filling the passage and the time required to complete cooling of the molding material filling the cavity can be reduced.

16 The above aspects may be such that thermal conductivity of the fourth mold is higher than thermal conductivity of the third mold.

According to such an aspect, the difference between the time required to complete cooling of the molding material filling the passage and the time required to complete cooling of the molding material filling the cavity can be reduced.

(7) The above aspects may be such that at least one of the third mold and the fourth mold is provided with a first heat insulating member for suppressing heat transfer between the third mold and the fourth mold.

According to this aspect, it is possible to suppress the temperature difference between the third mold and the fourth mold from becoming small due to the thermal conduction between the third mold and the fourth mold.

(8) The above aspects may be such that the fourth mold includes a first portion that includes a portion forming the cavity and a second portion that is distinct from the first portion and a cooling capacity of the second cooling section with respect to the first portion is lower than a cooling capacity of the second cooling section with respect to the second portion.

According to such an aspect, it is possible to suppress the first portion from being cooled to a temperature equal to or higher than that of the second portion.

(9) The above aspects may be such that the fourth mold is provided with a second heat insulating member that covers a portion in which the cavity is formed.

According to such an aspect, it is possible to suppress the generation of a temperature difference in the cavity.

What is claimed is:

1. An injection molding device comprising:
a plasticization section for plasticizing material to produce a molding material;
a fixed section to which an injection mold, in which is formed a cavity for defining shape of a product, is detachably attachable, the injection mold including a first mold that is formed with a gate aperture through which the molding material flows and a second mold that moves in a direction away from the first mold by mold opening; and
a nozzle formed with a flow path for guiding the molding material to the gate aperture, wherein
the second mold includes
a third mold and
a fourth mold arranged between the first mold and the third mold in a mold opening direction of the second mold, the cavity is formed by the third mold and the fourth mold,
a passage is formed in the fourth mold, through which the molding material passes from the gate aperture toward the cavity,
the third mold includes a first cooling section for cooling the third mold,
the fourth mold includes a second cooling section for cooling the fourth mold, and
a first cooling capacity of the first cooling section for the cavity is different from a second cooling capacity of the second cooling section for the passage.

2. The injection molding device according to claim 1, wherein
a volume of the passage is greater than a volume of the cavity and
the second cooling capacity is higher than the first cooling capacity.

3. The injection molding device according to claim 2, further comprising:
a control section that controls temperature of the first cooling section and temperature of the second cooling section, wherein
the control section controls the temperature of the second cooling section to be lower than the temperature of the first cooling section.

4. The injection molding device according to claim 2, wherein
a distance between the second cooling section and the passage is shorter than a distance between the first cooling section and the cavity.

5. The injection molding device according to claim 2, wherein
a surface area of the second cooling section with respect to the fourth mold is larger than a surface area of the first cooling section with respect to the third mold.

6. The injection molding device according to claim 2, wherein
thermal conductivity of the fourth mold is higher than thermal conductivity of the third mold.

7. The injection molding device according to claim 1, wherein
at least one of the third mold and the fourth mold is provided with a first heat insulating member for suppressing heat transfer between the third mold and the fourth mold.

8. The injection molding device according to claim 1, wherein
the fourth mold includes a first portion that includes a portion forming the cavity and a second portion that is distinct from the first portion and
a cooling capacity of the second cooling section with respect to the first portion is lower than a cooling capacity of the second cooling section with respect to the second portion.

9. The injection molding device according to claim 8, wherein
the fourth mold is provided with a second heat insulating member that covers a portion in which the cavity is formed.
